(19) United States
(12) Patent Application Publication
(10) Pub. No.: US 2026/0333457 A1
(43) Pub. Date: Oct. 22, 2026

(54) PRACH PREAMBLE FORMAT IN SBFD

(71) Applicant: Nokia Technologies Oy, Espoo (FI)

(72) Inventors: Jie GAO, Hangzhou, Zhejiang (CN); Elena PERALTA CALVO, Tampere (FI); Alessio MARCONE, Munich (DE); Nhat-Quang NHAN, Reims (FR); Jing Yuan SUN, Beijing (CN); Youngsoo YUK, Seoul (KR)

(21) Appl. No.: 19/482,752

(22) PCT Filed: May 11, 2023
(86) PCT No.: PCT/CN2023/093411

§ 371 Date: Nov. 9, 2025

(51) Int. Cl. H04W 74/0833; H04L 5/14

(52) U.S. Cl. CPC H04W 74/0833; H04L 5/14

(57) ABSTRACT

Embodiments of the present disclosure relate to PRACH preamble formats in SBFD. In an aspect, a terminal device receives, from a network device, configuration information indicative of a first PRACH preamble format applicable to SBFD slots. At least one sequence of the first PRACH preamble format is aligned in time domain with at least one sequence of a second PRACH preamble format applicable to non-SBFD slots. Based on determining that a condition for applying the first PRACH preamble format is met, the terminal device applies the first PRACH preamble format to a PRACH transmission to the network device. In this way, an SBFD terminal devise can use an ultra-long PRACH preamble format for UL coverage enhancement.

### FIELD

Various example embodiments relate to the field of telecommunication and in particular, to physical random-access channel (PRACH) preamble formats in sub-band full duplex (SBFD).

### BACKGROUND

In the communications area, there is a constant evolution ongoing in order to provide efficient and reliable solutions for utilizing wireless communication networks. To meet the demand for wireless data traffic having increased since deployment of 4th generation (4G) communication systems, efforts have been made to develop an improved new radio (NR) communication system. The new communication systems can support various types of service applications for terminal devices.

NR currently supports two duplexing modes: frequency division duplexing (FDD) for paired bands and time division duplexing (TDD) for unpaired bands. In TDD, the time domain resource is split between downlink and uplink. 3GPP has agreed to study on the evolution of duplexing operation in NR that may allow simultaneous DL and UL transmission on different physical resource blocks (PRBs) within an unpaired wideband NR cell. This may be referred to as SBFD, or cross-division duplexing (xDD), or flexible duplexing (FDU).

### SUMMARY

In general, example embodiments of the present disclosure provide a solution related to PRACH preamble formats in SBFD.

In a first aspect, there is provided a terminal device. The terminal device comprises at least one processor and at least one memory storing instructions that, when executed by the at least one processor, cause the terminal device at least to: receive, from a network device, configuration information indicative of a first PRACH preamble format applicable to SBFD slots, wherein at least one sequence of the first PRACH preamble format is aligned in time domain with at least one sequence of a second PRACH preamble format applicable to non-SBFD slots; and based on determining that a condition for applying the first PRACH preamble format is met, apply the first PRACH preamble format to a PRACH transmission to the network device.

In a second aspect, there is provided a network device. The network device comprises at least one processor and at least one memory storing instructions that, when executed by the at least one processor, cause the network device at least to: determine a first PRACH preamble format applicable to SBFD slots and a second PRACH preamble format applicable to non-SBFD slots, wherein at least one sequence of the first PRACH preamble format is aligned in time domain with at least one sequence of a second PRACH preamble format applicable to non-SBFD slots; and transmit, to a terminal device, configuration information indicative of the first PRACH preamble format.

In a third aspect, there is provided a method. The method comprises: receiving, from a network device, configuration information indicative of a first PRACH preamble format applicable to SBFD slots, wherein at least one sequence of the first PRACH preamble format is aligned in time domain with at least one sequence of a second PRACH preamble format applicable to non-SBFD slots; and based on determining that a condition for applying the first PRACH preamble format is met, applying the first PRACH preamble format to a PRACH transmission to the network device.

In a fourth aspect, there is provided a method. The method comprises: determining a first PRACH preamble format applicable to SBFD slots, wherein at least one sequence of the first PRACH preamble format is aligned in time domain with at least one sequence of a second PRACH preamble format applicable to non-SBFD slots; and transmitting, to a terminal device, configuration information indicative of the first PRACH preamble format.

In a fifth aspect, there is provided an apparatus. The apparatus comprises means for: receiving, from a network device, configuration information indicative of a first PRACH preamble format applicable to SBFD slots, wherein at least one sequence of the first PRACH preamble format is aligned in time domain with at least one sequence of a second PRACH preamble format applicable to non-SBFD slots; and based on determining that a condition for applying the first PRACH preamble format is met, applying the first PRACH preamble format to a PRACH transmission to the network device.

In a sixth aspect, there is provided an apparatus. The apparatus comprises means for: determining a first PRACH preamble format applicable to SBFD slots, wherein at least one sequence of the first PRACH preamble format is aligned in time domain with at least one sequence of a second PRACH preamble format applicable to non-SBFD slots; and transmitting, to a terminal device, configuration information indicative of the first PRACH preamble format.

In a seventh aspect, there is provided a non-transitory computer readable medium comprising program instructions for causing an apparatus to perform at least the method according to any one of the above third to fourth aspects.

In an eighth aspect, there is provided a computer program product comprising program instructions for performing at least the method according to any one of the above third to fourth aspects.

In a ninth aspect, there is provided a computer program comprising instructions, which, when executed by an apparatus, cause the apparatus to perform at least the method according to any one of the above third to fourth aspects.

In an tenth aspect, there is provided a terminal device. The terminal device comprises: receiving circuitry configured to receive, from a network device, configuration information indicative of a first PRACH preamble format applicable to SBFD slots, wherein at least one sequence of the first PRACH preamble format is aligned in time domain with at least one sequence of a second PRACH preamble format applicable to non-SBFD slots; and applying circuitry configured to, based on determining that a condition for applying the first PRACH preamble format is met, apply the first PRACH preamble format to a PRACH transmission to the network device.

In an eleventh aspect, there is provided a network device. The network device comprises: determining circuitry configured to determine a first PRACH preamble format applicable to SBFD slots, wherein at least one sequence of the first PRACH preamble format is aligned in time domain with at least one sequence of a second PRACH preamble format applicable to non-SBFD slots; and transmitting circuitry configured to transmit, to a terminal device, configuration information indicative of the first PRACH preamble format.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example communication system in which embodiments of the present disclosure may be implemented;

FIG. 1B illustrates a schematic diagram illustrating a time domain structure of different PRACH preamble formats;

FIG. 1C illustrates a schematic diagram illustrating frequency-time resource partitioning with SBFD as compared to traditional TDD;

FIG. 1D illustrates a schematic diagram illustrating a sequence in PRACH preamble format F0 not aligned with a sequence in PRACH preamble format F1;

FIG. 2 illustrates an example signaling chart of an example process according to some embodiments of the present disclosure;

FIG. 3 illustrates a schematic diagram illustrating new PRACH formats in SBFD used in TDD frame structure DSUU, according to some embodiments of the present disclosure;

FIG. 4 illustrates a schematic diagram illustrating a sequence in PRACH preamble format F0 aligned with a sequence in new PRACH preamble format F5-1, according to some embodiments of the present disclosure;

FIG. 5 illustrates a schematic diagram illustrating new PRACH formats in SBFD used in TDD frame structure DDDSUU, according to some embodiments of the present disclosure;

FIG. 6 illustrates a flowchart illustrating an example process according to some embodiments of the present disclosure;

FIG. 7 illustrates a schematic diagram illustrating a method implemented at a terminal device according to some other embodiments of the present disclosure;

FIG. 8 illustrates a schematic diagram illustrating a method implemented at a network device according to some other embodiments of the present disclosure;

FIG. 9 illustrates a simplified block diagram of an apparatus that is suitable for implementing embodiments of the present disclosure; and

FIG. 10 illustrates a block diagram of an example computer readable medium in accordance with some embodiments of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology. In the following description, the terms “network device”, “network (NW),” “gNB” and “BS” may be used interchangeably.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

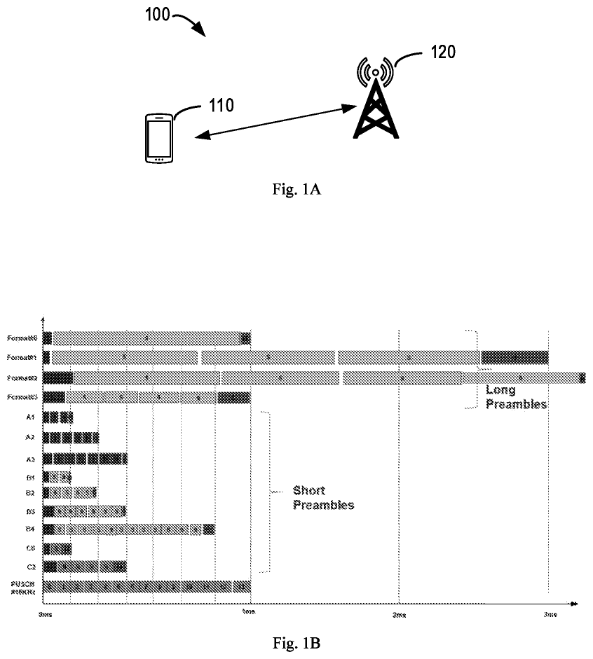

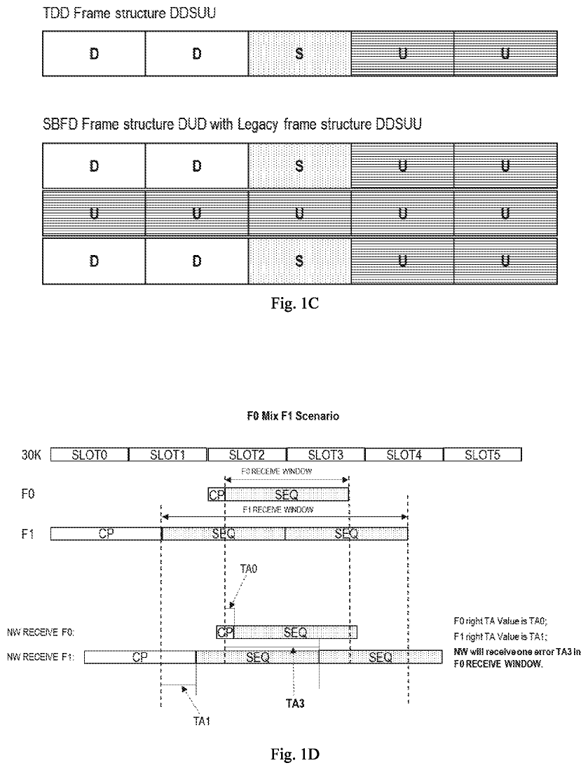

FIG. 1A illustrates an example communication system 100 in which embodiments of the present disclosure may be implemented. The system 100 includes terminal device 110 and network device 120. The terminal device 110 is capable of connecting and communicating in an UL or DL with the network device 120 as long as the terminal device 110 located within the corresponding cells. In communication systems, an UL refers to a link in a direction from a terminal device 110 to a network device 120, and a DL refers to a link in a direction from the network device 120 to the terminal device 110. The network device 120 may transmit scheduling information scheduling an uplink transmission to the terminal device 110, and the terminal device 110 may transmit a plurality of repetitions of the uplink transmission to the network device 120.

It is to be understood that the number of network devices 120 and terminal devices 110 is only for the purpose of illustration without suggesting any limitations. The system 100 may include any suitable number of network devices 120 and terminal devices 110 adapted for implementing embodiments of the present disclosure.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Some embodiments of the present disclosure may relate to random access (RA) procedure. RA refers to the procedure in which the UE synchronizes with its serving cell and obtains initial resources for uplink transmission. This is e.g. needed for initial access from radio resource control (RRC) Idle or RRC Inactive state.

Random access commonly consists of a 4-step RACH procedure and specified in TS 38.300. For contention-based RA, the four steps are as follows:
1. The UE first transmits a preamble in the so-called Msg1.
2. The gNB, upon receiving the preamble, replies to the UE by sending in the physical downlink shared channel (PDSCH) the detected preamble ID, the time-advance command, a temporary cell radio network temporary identity (TC-RNTI), and an uplink (UL) grant for the transmission of Msg3 on a physical uplink shared channel (PUSCH).
3. The UE responds to Msg2 over the scheduled PUSCH with an identity (ID) for contention resolution.
4. The gNB transmits the contention resolution message with the contention-resolution ID. Upon reception of Msg4, the UE sends an acknowledge (ACK) on a physical uplink control channel (PUCCH) if its contention-resolution ID is carried by Msg4. This completes the 4-step RACH.

Starting from Rel-16, there is also a 2-step RACH procedure which aims to improve the overall latency of the RACH procedure.

FIG. 1B illustrates a schematic diagram illustrating a time domain structure of different PRACH preamble formats, where the length of the cyclic prefix (C), the number of sequence repetitions (S) and guard period duration (G) (if any) are described. In this disclosure, a PRACH preamble format may be also referred to as a PRACH format.

NR currently supports two duplexing modes: frequency division duplexing (FDD) for paired bands and time division duplexing (TDD) for unpaired bands. In TDD, the time domain resource is split between downlink and uplink. Allocation of a limited time duration for the uplink in TDD would result in reduced coverage, increased latency, and reduced capacity.

Motivated by this, 3GPP has agreed to initiate a Rel-18 study item on the evolution of duplexing operation in NR that addresses the challenges above. One of the objectives of the study item is to allow simultaneous DL and UL transmission on different PRBs within an unpaired wideband NR cell, as shown in FIG. 1C, which illustrates a schematic diagram illustrating frequency-time resource partitioning with SBFD as compared to traditional TDD. In this disclosure, it is referred to as SBFD that simultaneous DL and UL transmission on different PRBs within an unpaired wideband NR cell, i.e., subband non-overlapping full duplex.

It should be noted that enabling PRACH transmission in SBFD symbols can increase PRACH capacity as well as reduce initial access delay. Moreover, PRACH coverage can also be enhanced as compared to only allowing PRACH transmissions in UL slots, e.g. by enabling PRACH transmissions spanning over more than one UL slot.

Usually for TDD networks with SCS is 30 kHz, due to the limitation of frame structure, when using long PRACH format, generally only format #0 (F0) can be considered at most, because it only occupies 1 ms of UL time, while F1, F2 format UL time exceeds 3 ms. There is no such limitation for SBFD, which can use a PRACH format that is more than 1 ms long. But when an SBFD UE using the F1 or F2 format and a legacy UE use F1 format in the same frequency with different slots, for example, referring to FIG. 1D, there are sequences (SEQs) not aligned in time. Then the NW will receive two SEQs of different PRACH formats that interfere each other in the PRACH receive window.

FIG. 1D illustrates a schematic diagram illustrating a sequence in F0 PRACH preamble format not aligned with a sequence in F1 PRACH preamble format. As shown in FIG. 1D, due to the unaligned F0 PRACH SEQ and F1 PRACH SEQ, the NW will receive one error time advance (TA) 3 in F0 receive window.

In view of the above and other aspects, embodiments of the present disclosure provide a solution for improving PRACH preamble formats in SBFD. For example, a terminal device may receive, from a network device, configuration information indicative of a first PRACH preamble format applicable to SBFD slots. At least one sequence of the first PRACH preamble format is aligned in time domain with at least one sequence of a second PRACH preamble format applicable to non-SBFD slots. Based on determining that a condition for applying the first PRACH preamble format is met, the terminal device may apply the first PRACH preamble format to a PRACH transmission to the network device. In this way, an SBFD terminal devise can use an ultra-long PRACH preamble format for UL coverage enhancement, while a traditional UE can simultaneously use PRACH preamble format based on TDD frame structure.

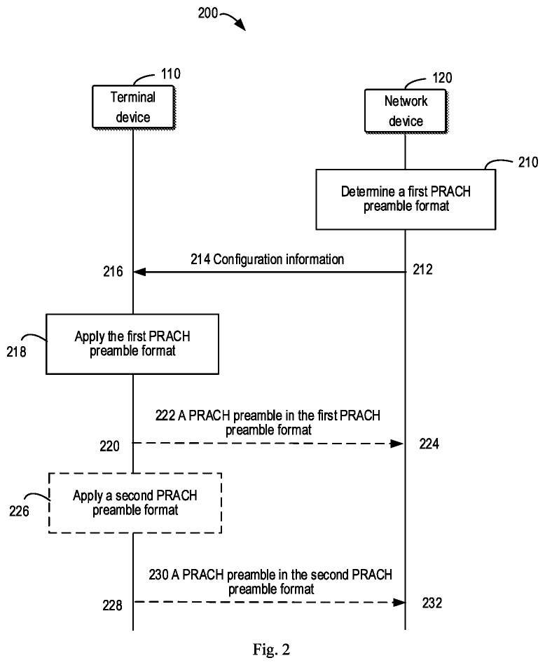

FIG. 2 illustrates an example signaling chart illustrating an example process 200 according to some embodiments of the present disclosure. For the purpose of discussion, the example process 200 will be described with reference to FIG. 1A, and the process 200 may involve the terminal device 110 and the network device 120 as shown in FIG. 1A.

As shown in FIG. 2, the network device 120 determines 210 a first PRACH preamble format applicable to SBFD slots. At least one sequence of the first PRACH preamble format is aligned in time domain with at least one sequence of a second PRACH preamble format applicable to non-SBFD slots. Then, the network device 120 transmits 212 configuration information 214 indicative of the first PRACH preamble format to the terminal device 110. The terminal device 110 receives 216 the configuration information. The configuration information may be transmitted via system information or dedicated signaling.

The configuration information may comprise a TDD frame structure and a SBFD structure. An SBFD UE can apply the first PRACH preamble format (e.g., a new long PRACH preamble format) in the SBFD structure. A legacy UE may use a legacy PRACH preamble format in the TDD frame structure.

Moreover, the configuration information may comprise a PRACH index and PRACH occasion and/or a contention-based (CB) preamble. In another case, the configuration information may comprise a delta CP value. Alternatively, delta CP values may be predefined and the configuration information may comprise a delta CP index.

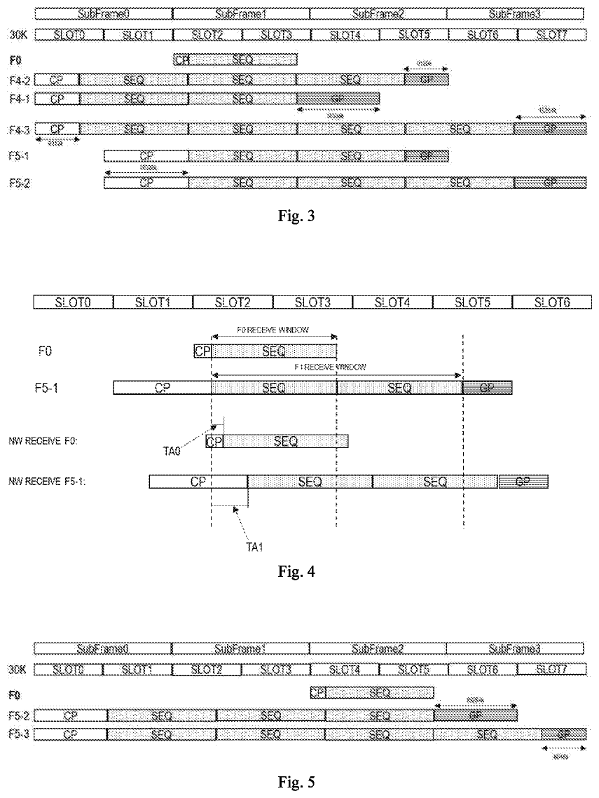

To align at least one sequence of the first PRACH preamble format with at least one sequence of a second PRACH preamble format, a CP value of the first PRACH preamble format may be determined such that a start time of the at least one sequence of the first PRACH preamble format is aligned with a start time of at least one sequence of the second PRACH preamble format. In other words, the length of the CP may be used as a tool to delay the start time of at least one of the sequences to realize the time-alignment. As a consequence, the sequences (SEQ in FIG. 3) will start at the same time.

If the terminal device 110 determines that a condition for applying the first PRACH preamble format is met, the terminal device 110 applies 218 the first PRACH preamble format to a PRACH transmission to the network device 120.

The condition for applying the first PRACH preamble format may comprise the terminal device being an SBFD aware device. The SBFD aware device may determine whether to apply new feature. For example, the condition may comprise a configuration of the first PRACH preamble format being activated at the terminal device 110.

In addition, the condition may comprise a parameter indicative of a received quality of a synchronization signal block (SSB) at the terminal device 110 being below than a threshold. The parameter may be a reference signal received power (RSRP), a signal to interference plus noise ratio (SINR), a reference signal received quality (RSRQ), or other parameters.

In some scenarios, the SBFD UE may require highly reliable access, and thus the condition for applying the first PRACH preamble format may comprise a parameter related to access reliability. Alternatively, the condition may comprise a threshold for the number of times the SBFD UE fails in legacy PRACH. In other scenarios, the condition may relate to the SBFD UE being in the special feature, a small data transmission (SDT), handover, etc.

If the terminal device 110 applies the first PRACH preamble format, the terminal device 110 may transmit 220 a PRACH preamble in the first PRACH preamble format 222 during continuous SBFD slots and UL slots to the network device 120. Upon receiving 224 the PRACH preamble in the first PRACH preamble format, the network device 120 may determine that the PRACH preamble is a long PRACH preamble and process the long PRACH preamble accordingly.

On the network side, the at least one sequence of the PRACH preamble received from the terminal device 110 may be fully overlapped and aligned in the time domain with the at least one sequence of a further PRACH preamble in the second PRACH preamble format received from a further network device. Since the sequences are aligned, the preambles in different PRACH formats can be processed jointly in a single process by the network device 120.

If the terminal device 110 determines that the condition for applying the first PRACH preamble format is not met, the terminal device 110 may apply 226 the second PRACH preamble format to the PRACH transmission to the network device 120. In this case, the terminal device 110 may transmit 228 a PRACH preamble in the second PRACH preamble format 230 during continuous SBFD slots and UL slots to the network device 120. The network device 120 can receive 232 the PRACH preamble in the second PRACH preamble format and then perform the corresponding process.

The PRACH preamble formats will be introduced in detail below. In some embodiments of the present disclosure, a set of random-access preambles x_{u,v}(n) can be generated according to

$$\begin{matrix}{x}_{u , v} ( n ) = {x}_{u} ( ( n + {C}_{v} ) mod {L}_{RA} ) \\ {x}_{u} ( i ) = {e}^{- j \frac{π u i ( i + 1 )}{{L}_{RA}}} , i = 0 , 1 , … , {L}_{RA} - 1\end{matrix} .$$

From the above formulas, the frequency-domain representation can be generated according to

$${y}_{u , v} ( n ) = {\sum }_{m = 0}^{{L}_{R A} - 1} {x}_{u , v} ( m ) \cdot {e}^{- j \frac{2 π mn}{{L}_{RA}}}$$

where L_{RA}=839 depending on the PRACH preamble formats as given by Table 1 below.

There are 64 preambles defined in each time-frequency PRACH occasion, enumerated in increasing order of first increasing cyclic shift Cᵥ of a logical root sequence, and then in increasing order of the logical root sequence index, starting with the index obtained from the higher-layer parameter prach-RootSequenceIndex. Additional preamble sequences, in case 64 preambles cannot be generated from a single root Zadoff-Chu sequence, are obtained from the root sequences with the consecutive logical indexes until all the 64 sequences are found. The logical root sequence order is cyclic; the logical index 0 is consecutive to 837 when L_{RA}=839. The sequence number u is obtained from the logical root sequence index.

TABLE 1
PRACH preamble formats including new PRACH
preamble formats 4, 5, 6.

| Format | L_{RA} | Δf_{RA} | | Nᵤ | ${N}_{C P}^{R A}$ | Support for restricted sets |
|---|---|---|---|---|---|---|
| 0 | 839 | 1.25 | kHz | 24576k | 3168k | Type A, Type B |
| 1 | 839 | 1.25 | kHz | 2-24576k | 21024k | Type A, Type B |
| 2 | 839 | 1.25 | kHz | 4-24576k | 4688k | Type A, Type B |
| 3 | 839 | 5 | kHz | 4-6144k | 3168k | Type A, Type B |
| 4-1 | 839 | 1.25 | kHz | 2-24576k | 9312k | Type A, Type B |
| 4-2 | 839 | 1.25 | kHz | 3-24576k | 9312k | Type A, Type B |
| 4-3 | 839 | 1.25 | kHz | 4-24576k | 9312k | Type A, Type B |
| 5-1 | 839 | 1.25 | kHz | 2-24576k | 18528k | Type A, Type B |
| 5-2 | 839 | 1.25 | kHz | 3-24576k | 18528k | Type A, Type B |
| 5-3 | 839 | 1.25 | kHz | 4-24576k | 18528k | Type A, Type B |
| 6-0 | 839 | 5 | kHz | 8-6144k | 3168k | Type A, Type B |
| 6-1 | 839 | 5 | kHz | 4-6144k | 12384k | Type A, Type B |
| . . . | | | | | | |

Throughout the present disclosure, unless otherwise noted, the size of various fields in the time domain is expressed in time units T_{c}=1/(Δfₘₐₓ·N_{f}) where Δfₘₐₓ=480·10³ Hz and N_{f}=40% The constant κ=Tₛ/T_{c}=64 where Tₛ=1/(Δf_{ref}·N_{f,ref}), Δf_{ref}=15·10³ Hz and N_{f,ref}=2048.

In Table 1, new PRACH preamble formats 4-1 to 4-3, 5-1 to 5-3, and 6-1 to 6-2 are provided. The new PRACH preamble formats have a plurality of CP lengths

$$( {N}_{C P}^{R A} )$$

and numbers of sequences (Nᵤ). It is noted that new PRACH preamble formats are provided as examples without suggesting any limitations. There may be other PRACH preamble formats suitable for SBFD scenarios, which are also within the scope of the present disclosure.

The new PRACH preamble formats in SBFD will be described below with certain exemplary TDD frame structures by referring to FIGS. 3 to 5.

FIG. 3 illustrates a schematic diagram illustrating new PRACH formats in SBFD used in TDD frame structure DSUU, where slots 0,1 are SBFD slots, and slots 2,3 are non-SBFD slots.

In a communication process using new PRACH formats in SBFD, the NW (e.g., the network device 120) may indicate and the UE (e.g., the terminal device 110) may receive configurations of: common TDD frame structure configuration, i.e., DSUU; a SBFD structure configuration, i.e., DUD; a legacy UE configuration of PRACH format0 in slot 2; and an SBFD UE configuration of new PRACH format. In this example, the new PRACH format for the SBFD UE may be one of format 4-1 or 4-2 or 4-3 or 5-1 or 5-2 in Table 1. Signaling for RACH configuration will be described later.

Then, the legacy UE may send PRACH format 0 in slots 2, 3. The SBFD UE may use format 4-1 or 4-2 or 4-3 in slot 0, or the SBFD UE may use format 5-1 or 5-2 in slot 1, as shown in FIG. 3.

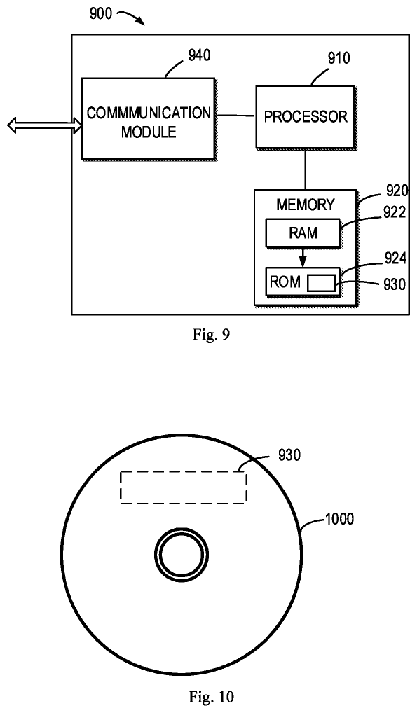

The NW may receive the PRACH in different slots and one SEQ of the new format is full overlap and aligns with legacy format0's SEQ, which is shown in FIG. 9. The NW can single process with two right TA value and no add additional TA value.

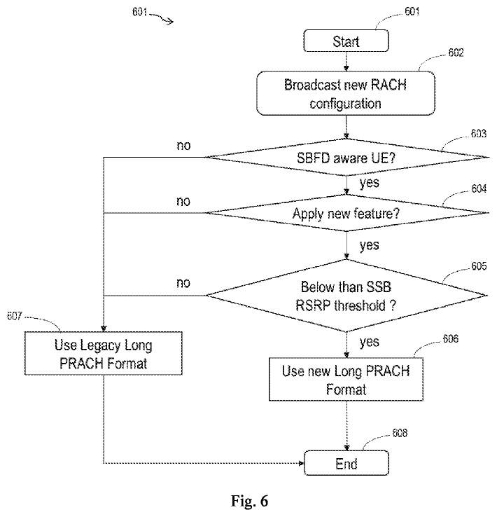

As another example, FIG. 5 illustrates a schematic diagram illustrating new PRACH formats in SBFD used in TDD frame structure DDDSUU, where slots 0,1,2,3 are SBFD slots, and slots 4,5 are non-SBFD slots.

In an exemplary communication process, the NW (e.g., the network device 120) may indicate and the UE (e.g., the terminal device 110) may receive configurations of: common TDD frame structure configuration, i.e., DDDSUU; a SBFD structure configuration, i.e., DUD; a legacy UE configuration of PRACH format0 in slot 4; and an SBFD UE configuration of new PRACH format. In this example, the new PRACH format for the SBFD UE may be one of format 5-1 or 5-2 or 5-3 in Table 1.

Then, the legacy UE may send PRACH format 0 in slots 4, 5. The SBFD UE may use format 5-1 or 5-2 or 5-3 in slot 0, as shown in FIG. 5.

The NW may receive the PRACH in different slots and one SEQ of the new format is full overlap and aligns with legacy format0's SEQ, so the NW can single process.

The configuration may be transmitted via system information or dedicated signaling, such RRC signaling. In the RRC signaling for RACH configuration, prach-ConfigurationIndex. ssb-perRACH-OccasionAndCB-PreamblesPerSSB and rsrp-ThresholdSSB are defined for legacy UEs (format 0 in the given example), and an additional new-prach-configurationindex-secondary, ssb-perRACH-OccasionAndCB-PreamblesPerSSB-secondary and rsrp-ThresholdSSB-secondary (format 4 or 5 in the given example) are defined for SBFD users.

A new RRC parameter inside rach-ConfigGeneric can be defined for SBFD UEs in order to time-align with PRACH format 0.

In an option, the new-prach-ConfigurationIndex (i.e., new-prach-configurationindex-secondary) could be signaled via RRC by the gNB to map new PRACH format.

In another option, the prach-configurationindex-secondary and a new parameter delta-CP value could be signaled via RRC by the gNB to compensate for the CP difference to PRACH format 1 and PRACH format 2. For example, PRACH format is 4, prach-configurationindex is format 1, then the delta-CP value=format 4 CP length−format 1 CP length.

In another option, the prach-configurationindex-secondary and a new parameter delta-CP-index could be signaled via RRC by the gNB to compensate for the CP difference to PRACH format 1 and PRACH format 2. For example, delta-CP-index may be predefined, and delta-CP-index value is mapping to current PRACH format CP difference.

It should be understood that embodiments of the present disclosure also can be used for legacy PRACH format 3 due to PRACH format 3 is same symbols length with PRACH format 0 in slots. In addition, based on this single SEQ full alignment, more compatible new PRACH formats can be extended. Such modifications and extensions are within the scope of the present disclosure.

FIG. 6 illustrates a flowchart illustrating an example process 600 according to some embodiments of the present disclosure. The process 600 can be an example of the process 200 shown in FIG. 2.

In process 600, a new long PRACH format is used for UL coverage enhancement in SBFD, and legacy TDD UE can compatible with new PRACH format. Different PRACH formats can single processing at gNB side for the mixed PRACH framework. In process 600, the new PRACH format could be control by some threshold, e.g., SSB RSRP, SINR, RSRQ, etc. The SBFD aware UE can more flexible to select whether or not to use the new and super long PRACH format based on the user current scenario.

The process 600 may start from 601. At 602, the gNB (e.g., the network device 120) may broadcast new RACH configuration, such as the configuration or configuration information described above with reference to FIGS. 2-5.

At 602, a UE (e.g., the terminal device 110) that received the new RACH configuration may determine whether it is an SBFD aware UE or not. If not, at 607, the UE use a legacy long PRACH format. If the UE is an SBFD aware UE, it may determine whether to apply new feature or not. If not, at 607, the UE use a legacy long PRACH format. If the UE determines to apply new feature, then the UE may determine whether a parameter is below than a threshold. As described above, the new PRACH format could be control by some threshold, e.g., SSB RSRP, SINR, RSRQ, etc. If the parameter is not below than the threshold, the UE use a legacy long PRACH format. If the parameter is below than the threshold, at 606, the UE use a new long PRACH format, such as the new PRACH formats in Table 1. The process 600 may end at 608.

Embodiments of the present disclosure provide a solution of PRACH preamble formats in SBFD. The solution introduces new PRACH formats in SBFD. It can cancel the interference caused by different transmitted preambles in the cell, and reduce the complexity of processing. Moreover, different PRACH formats can be single process by gNB.

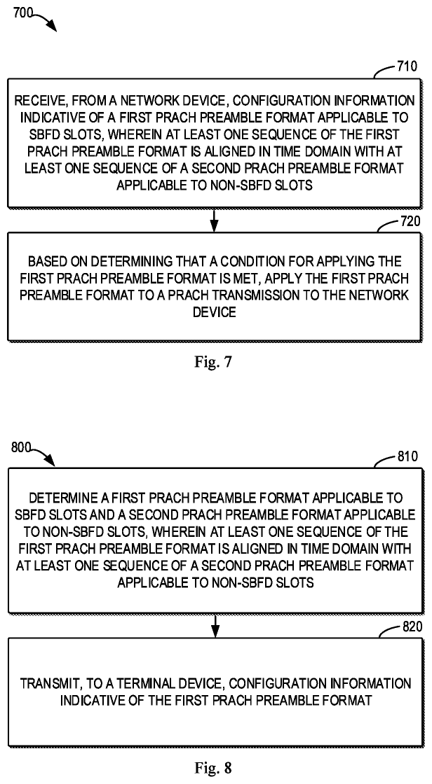

FIG. 7 illustrates a schematic diagram illustrating a method 700 implemented at a terminal device according to some other embodiments of the present disclosure. For the purpose of discussion, the method 700 will be described from the perspective of the terminal device 110 as shown in, e.g., FIGS. 1A and 2.

As shown in FIG. 7, at block 710, the terminal device 110 receives, from a network device 120, configuration information indicative of a first PRACH preamble format applicable to SBFD slots. At least one sequence of the first PRACH preamble format is aligned in time domain with at least one sequence of a second PRACH preamble format applicable to non-SBFD slots.

At block 720, based on determining that a condition for applying the first PRACH preamble format is met, the terminal device 110 applies the first PRACH preamble format to a PRACH transmission to the network device.

In some embodiments, a CP value of the first PRACH preamble format may be determined such that a start time of the at least one sequence of the first PRACH preamble format is aligned with a start time of at least one sequence of the second PRACH preamble format.

In some embodiments, based on applying the first PRACH preamble format, the terminal device 110 may transmit, to the network device, a PRACH preamble in the first PRACH preamble format during continuous SBFD slots and uplink UL slots.

Alternatively or in addition, the configuration information may further indicate the second PRACH preamble format, and based on determining that the condition for applying the first PRACH preamble format is not met, the terminal device 110 may apply the second PRACH preamble format to the PRACH transmission to the network device.

In some embodiments, the terminal device 110 may receive the configuration information via system information or dedicated signaling. In some embodiments, the configuration information may comprise a PRACH index and PRACH occasion. Alternatively or in addition, the configuration information may comprise a CB preamble. Alternatively or in addition, the configuration information may comprise a delta CP value. Alternatively or in addition, the configuration information may comprise a delta CP index.

In some embodiments, the condition may comprise the terminal device being an SBFD aware device. Alternatively or in addition, the condition may comprise a configuration of the first PRACH preamble format being activated at the terminal device. Alternatively or in addition, the condition may comprise a parameter indicative of a received quality of a SSB at the terminal device 110 being below than a threshold. The parameter may comprise one of: RSRP, SINR, or RSRQ.

In some embodiments, the configuration information may comprise a TDD frame structure and a SBFD structure.

FIG. 8 illustrates a schematic diagram illustrating a method 800 implemented at a network device according to some other embodiments of the present disclosure. For the purpose of discussion, the method 800 will be described from the perspective of the network device 120 as shown in, e.g., FIGS. 1A and 2.

As shown in FIG. 8, at block 810, the network device 120 determines a first PRACH preamble format applicable to SBFD slots. At least one sequence of the first PRACH preamble format is aligned in time domain with at least one sequence of a second PRACH preamble format applicable to non-SBFD slots.

At block 820, the network device 120 transmits, to a terminal device 110, configuration information indicative of the first PRACH preamble format.

In some embodiments, a CP value of the first PRACH preamble format may be determined such that a start time of the at least one sequence of the first PRACH preamble format is aligned with a start time of at least one sequence of the second PRACH preamble format.

In some embodiments, the network device 120 may transmit the configuration information via system information or dedicated signaling. In some embodiments, the network device 120 may receive, from the terminal device 110, a PRACH preamble in the first PRACH preamble format during continuous SBFD slots and UL slots. In some embodiments, the network device 120 may determine that the PRACH preamble is a long PRACH preamble and process the long PRACH preamble.

In some embodiments, the configuration information may further indicate the second PRACH preamble format. In some embodiments, the at least one sequence of the PRACH preamble may be full overlap and aligned in the time domain with the at least one sequence of a further PRACH preamble in the second PRACH preamble format received from a further network device.

In some embodiments, the network device 120 may process the at least one sequence of the PRACH preamble with a first TA value and process the at least one sequence of the further PRACH preamble with a second TA value.

In some embodiments, the configuration information may comprise a PRACH index and PRACH occasion. Alternatively or in addition, the configuration information may comprise a CB preamble. Alternatively or in addition, the configuration information may comprise a delta CP value. Alternatively or in addition, the configuration information may comprise a delta CP index. In some embodiments, the configuration information may comprise a TDD frame structure and a SBFD structure.

In some embodiments, an apparatus capable of performing any of the method 700 (for example, the terminal device 110) may comprise means for performing the respective steps of the method 700. The means may be implemented in any suitable form. For example, the means may be implemented in a circuitry or software module.

In some embodiments, the apparatus comprises: means for receiving, from a network device, configuration information indicative of a first physical random-access channel (PRACH) preamble format applicable to sub-band full duplex (SBFD) slots, wherein at least one sequence of the first PRACH preamble format is aligned in time domain with at least one sequence of a second PRACH preamble format applicable to non-SBFD slots; and means for based on determining that a condition for applying the first PRACH preamble format is met, applying the first PRACH preamble format to a PRACH transmission to the network device.

In some embodiments, a cyclic prefix (CP) value of the first PRACH preamble format is determined such that a start time of the at least one sequence of the first PRACH preamble format is aligned with a start time of at least one sequence of the second PRACH preamble format.

In some embodiments, the apparatus further comprises means for based on applying the first PRACH preamble format, transmit, to the network device, a PRACH preamble in the first PRACH preamble format during continuous SBFD slots and uplink (UL) slots.

In some embodiments, the configuration information further indicates the second PRACH preamble format, and the apparatus further comprises means for based on determining that the condition for applying the first PRACH preamble format is not met, apply the second PRACH preamble format to the PRACH transmission to the network device.

In some embodiments, the means for receiving the configuration information comprises means for receiving the configuration information via system information or dedicated signaling. In some embodiments, the configuration information comprises at least one of the following: a PRACH index and PRACH occasion, a contention-based (CB) preamble, a delta CP value, or a delta CP index.

In some embodiments, the condition comprises the terminal device being an SBFD aware device. In some embodiments, the condition comprises a configuration of the first PRACH preamble format being activated at the terminal device. In some embodiments, the condition comprises a parameter indicative of a received quality of a synchronization signal block (SSB) at the terminal device being below than a threshold. In some embodiments, the parameter comprises one of the following: a reference signal received power (RSRP), a signal to interference plus noise ratio (SINR), or a reference signal received quality (RSRQ).

In some embodiments, the configuration information comprises a time division duplex (TDD) frame structure and a SBFD structure.

In some embodiments, the apparatus further comprises means for performing other steps in some embodiments of the method 700. In some embodiments, the means comprises at least one processor and at least one memory including computer program code, the at least one memory and computer program code configured to, with the at least one processor, cause the performance of the apparatus.

In some embodiments, an apparatus capable of performing any of the method 800 (for example, the network device 120) may comprise means for performing the respective steps of the method 800. The means may be implemented in any suitable form. For example, the means may be implemented in a circuitry or software module.

In some embodiments, the apparatus comprises: means for determining a first physical random-access channel (PRACH) preamble format applicable to sub-band full duplex (SBFD) slots, wherein at least one sequence of the first PRACH preamble format is aligned in time domain with at least one sequence of a second PRACH preamble format applicable to non-SBFD slots; and means for transmitting, to a terminal device, configuration information indicative of the first PRACH preamble format.

In some embodiments, a cyclic prefix (CP) value of the first PRACH preamble format is determined such that a start time of the at least one sequence of the first PRACH preamble format is aligned with a start time of at least one sequence of the second PRACH preamble format.

In some embodiments, the means for transmitting the configuration information comprises means for transmitting the configuration information via system information or dedicated signaling.

In some embodiments, the apparatus further comprises means for receiving, from the terminal device, a PRACH preamble in the first PRACH preamble format during continuous SBFD slots and uplink (UL) slots. In some embodiments, the apparatus further comprises means for determining that the PRACH preamble is a long PRACH preamble; and the apparatus further comprises means for processing the long PRACH preamble.

In some embodiments, the configuration information further indicates the second PRACH preamble format. In some embodiments, the at least one sequence of the PRACH preamble is full overlap and aligned in the time domain with the at least one sequence of a further PRACH preamble in the second PRACH preamble format received from a further network device.

In some embodiments, the apparatus further comprises means for processing the at least one sequence of the PRACH preamble with a first time advance (TA) value; and the apparatus further comprises means for processing the at least one sequence of the further PRACH preamble with a second TA value.

In some embodiments, the configuration information comprises at least one of the following: a PRACH index and PRACH occasion, a contention-based (CB) preamble, a delta CP value, or a delta CP index. In some embodiments, the configuration information comprises a time division duplex (TDD) frame structure and a SBFD structure.

In some embodiments, the apparatus further comprises means for performing other steps in some embodiments of the method 800. In some embodiments, the means comprises at least one processor and at least one memory including computer program code, the at least one memory and computer program code configured to, with the at least one processor, cause the performance of the apparatus.

FIG. 9 is a simplified block diagram of a device 900 that is suitable for implementing embodiments of the present disclosure. The device 900 may be provided to implement the communication device, for example the terminal device 110, or the network device 120 as shown in FIG. 1A. As shown, the device 900 includes one or more processors 910, one or more memories 920 coupled to the processor 910, and one or more communication modules 940 coupled to the processor 910.

The communication module 940 is for bidirectional communications. The communication module 940 has at least one antenna to facilitate communication. The communication interface may represent any interface that is necessary for communication with other network elements.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The program 930 may be stored in the ROM 920. The processor 910 may perform any suitable actions and processing by loading the program 930 into the RAM 920.

The embodiments of the present disclosure may be implemented by means of the program 930 so that the device 900 may perform any process of the disclosure as discussed with reference to FIGS. 2 to 8. The embodiments of the present disclosure may also be implemented by hardware or by a combination of software and hardware.

In some embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. The computer readable medium may include any types of tangible non-volatile storage, such as ROM, EPROM, a flash memory, a hard disk, CD, DVD, and the like. FIG. 10 shows an example of the computer readable medium 1000 in form of CD or DVD. The computer readable medium has the program 930 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 700 or the method 800 as described above with reference to FIGS. 7-8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A terminal device comprising:
at least one processor, and
at least one memory storing instructions that, when executed by the at least one processor, cause the terminal device at least to:
receive, from a network device, configuration information indicative of a first physical random-access channel (PRACH) preamble format applicable to sub-band full duplex (SBFD) slots, wherein at least one sequence of the first PRACH preamble format is aligned in time domain with at least one sequence of a second PRACH preamble format applicable to non-SBFD slots; and
based on determining that a condition for applying the first PRACH preamble format is met, apply the first PRACH preamble format to a PRACH transmission to the network device.

2. The terminal device of claim 1, wherein a cyclic prefix (CP) value of the first PRACH preamble format is determined such that a start time of the at least one sequence of the first PRACH preamble format is aligned with a start time of at least one sequence of the second PRACH preamble format.

3. The terminal device of claim 1 or 2, wherein the terminal device is further caused to:
based on applying the first PRACH preamble format, transmit, to the network device, a PRACH preamble in the first PRACH preamble format during continuous SBFD slots and uplink (UL) slots.

4. The terminal device of any of claims 1-3, wherein the configuration information further indicates the second PRACH preamble format, and the terminal device is further caused to:
based on determining that the condition for applying the first PRACH preamble format is not met, apply the second PRACH preamble format to the PRACH transmission to the network device.

5. The terminal device of any of claim 1-4, wherein the terminal device is caused to receive the configuration information by:
receiving the configuration information via system information or dedicated signaling.

6. The terminal device of any of claims 1-5, wherein the configuration information comprises at least one of the following:
a PRACH index and PRACH occasion,
a contention-based (CB) preamble,
a delta CP value, or
a delta CP index.

7. The terminal device of any of claims 1-6, wherein the condition comprises the terminal device being an SBFD aware device.

8. The terminal device of any of claims 1-7, wherein the condition comprises:
a configuration of the first PRACH preamble format being activated at the terminal device.

9. The terminal device of any of claims 1-8, wherein the condition comprises:
a parameter indicative of a received quality of a synchronization signal block (SSB) at the terminal device being below than a threshold.

10. The terminal device of claim 9, wherein the parameter comprises one of the following:
a reference signal received power (RSRP),
a signal to interference plus noise ratio (SINR), or
a reference signal received quality (RSRQ).

11. The terminal device of any of claims 1-10, wherein the configuration information comprises a time division duplex (TDD) frame structure and a SBFD structure.

12. A network device comprising:
at least one processor, and
at least one memory storing instructions that, when executed by the at least one processor, cause the network device at least to:
determine a first physical random-access channel (PRACH) preamble format applicable to sub-band full duplex (SBFD) slots, wherein at least one sequence of the first PRACH preamble format is aligned in time domain with at least one sequence of a second PRACH preamble format applicable to non-SBFD slots; and
transmit, to a terminal device, configuration information indicative of the first PRACH preamble format.

13. The network device of claim 12, wherein a cyclic prefix (CP) value of the first PRACH preamble format is determined such that a start time of the at least one sequence of the first PRACH preamble format is aligned with a start time of at least one sequence of the second PRACH preamble format.

14. The network device of claim 12 or 13, wherein the network device is caused to transmit the configuration information by:
transmitting the configuration information via system information or dedicated signaling.

15. The network device of any of claims 12-14, wherein the network device is further caused to:
receive, from the terminal device, a PRACH preamble in the first PRACH preamble format during continuous SBFD slots and uplink (UL) slots.

16. The network device of any of claims 12-15, wherein the network device is further caused to:
determine that the PRACH preamble is a long PRACH preamble; and
process the long PRACH preamble.

17. The network device of any of claims 12-16, wherein the configuration information further indicates the second PRACH preamble format.

18. The network device of any of claims 12-17, wherein the at least one sequence of the PRACH preamble is full overlap and aligned in the time domain with the at least one sequence of a further PRACH preamble in the second PRACH preamble format received from a further network device.

19. The network device of claim 18, wherein the network device is further caused to:
process the at least one sequence of the PRACH preamble with a first time advance (TA) value; and
process the at least one sequence of the further PRACH preamble with a second TA value.

20. The network device of any of claims 12-19, wherein the configuration information comprises at least one of the following:
a PRACH index and PRACH occasion,
a contention-based (CB) preamble,
a delta CP value, or
a delta CP index.

21. The network device of any of claims 12-20, wherein the configuration information comprises a time division duplex (TDD) frame structure and a SBFD structure.

22. A method comprising:
receiving, from a network device, configuration information indicative of a first physical random-access channel (PRACH) preamble format applicable to sub-band full duplex (SBFD) slots, wherein at least one sequence of the first PRACH preamble format is aligned in time domain with at least one sequence of a second PRACH preamble format applicable to non-SBFD slots; and
based on determining that a condition for applying the first PRACH preamble format is met, applying the first PRACH preamble format to a PRACH transmission to the network device.

23. A method comprising:
determining a first physical random-access channel (PRACH) preamble format applicable to sub-band full duplex (SBFD) slots, wherein at least one sequence of the first PRACH preamble format is aligned in time domain with at least one sequence of a second PRACH preamble format applicable to non-SBFD slots; and
transmitting, to a terminal device, configuration information indicative of the first PRACH preamble format.

24. An apparatus comprising means for:
receiving, from a network device, configuration information indicative of a first physical random-access channel (PRACH) preamble format applicable to sub-band full duplex (SBFD) slots, wherein at least one sequence of the first PRACH preamble format is aligned in time domain with at least one sequence of a second PRACH preamble format applicable to non-SBFD slots; and
based on determining that a condition for applying the first PRACH preamble format is met, applying the first PRACH preamble format to a PRACH transmission to the network device.

25. An apparatus comprising means for:
determining a first physical random-access channel (PRACH) preamble format applicable to sub-band full duplex (SBFD) slots, wherein at least one sequence of the first PRACH preamble format is aligned in time domain with at least one sequence of a second PRACH preamble format applicable to non-SBFD slots; and
transmitting, to a terminal device, configuration information indicative of the first PRACH preamble format.

26. A computer readable medium comprising program instructions that, when executed by an apparatus, cause the apparatus to perform at least one of the methods of claims 22 and 23.
